(19) United States
(12) Patent Application Publication
(10) Pub. No.: US 2011/0186075 A1
(43) Pub. Date: Aug. 4, 2011

(54) Vacuum cleaners

(75) Inventors: Glyn Hauser, Rotherham (GB); James Meddick, Rotherham (GB); David Kelly, Roslin (GB)

(73) Assignee: Morphy Richards Limited

(21) Appl. No.: 12/658,137

(22) Filed: Feb. 3, 2010

(51) Int. Cl. A47L 9/02; B08B 7/00

(52) U.S. Cl. 134/6; 15/415.1

(57) ABSTRACT

An attachment for a vacuum cleaner includes a suction head which includes a suction chamber to create and contain a region of low pressure adjacent to a surface to be cleaned. The suction head includes a number of air bleeds and these may be arranged as a first array first air bleeds and a second row of second air bleeds. Each air bleed is arranged to induce cyclonic airflow as the atmospheric airflows into the suction chamber. This cyclonic airflow is directed towards the surface to be cleaned and, in particular, an apex of this cyclonic airflow is arranged to coincide or penetrate the surface to be cleaned. For example, the apex of the cyclonic airflow may locate within the carpet fibers of a carpet in order to disturb and disrupt dust and debris within the carpet. Accordingly, the cyclonic air bleeds agitate the surface to be cleaned whilst also performing the function of a conventional air bleed within a suction head of a vacuum cleaner.

### CROSS REFERENCE TO RELATED APPLICATION(S)

N.A.

### U.S. GOVERNMENT RIGHTS

N.A.

### BACKGROUND OF THE INVENTION

1. Field of the Invention

The present invention relates to improvements in and relating to vacuum cleaners and, in particular, relates to improvements in and relating to vacuum suction heads for vacuum cleaners. More specifically, the present invention provides improvements relating to the agitation of surfaces to be cleaned and/or the flow of air into a suction head of a vacuum cleaner.

2. Description of the Related Art

Vacuum cleaners include suction heads in order to locate and confine an area of suction adjacent to a surface to be cleaned. The suction head includes a peripheral surface or peripheral seal in order for the suction head to form a seal against the surface. A system chamber in the suction head then extracts debris and dust from the surface by the suction power generated by the suction generating means of the vacuum cleaner, for instance its motor and fan units.

If the suction head creates a firm seal with the surface then a user will not be able to manually move the cleaning head across the surface to be cleaned. Accordingly, vacuum cleaning heads require air inflow regions or air bleeds. These air bleeds produce airflow from the external atmosphere into a suction chamber in the suction head. The air then flows from the suction head through a connecting tube or conduit and into a dust collecting chamber of the vacuum cleaner. The air then flows out of the chamber and back into the atmosphere.

The air bleeds on the suction head are necessary but effectively waste suction energy. On carpeted or other irregular surfaces, the air bleeds may naturally occur due to the inability of the peripheral seal of the cleaning head to form an airtight seal with the surface. However, on a smooth hard surface, the cleaning head may readily create a substantially air tight seal and, therefore, air bleeds are required or a non-continuous peripheral surface (for example, a brush seal) may locate around the cleaning head and acts as air bleeds and produce air inflow into the cleaning head which is approximately co-planar with the surface being cleaned.

Vacuum cleaners and, in particular, upright vacuum cleaners generally include an agitator in the cleaning head. The agitator may include a brush bar which includes a brush mounted on a rotating cylinder such that the brush agitates and releases dirt and debris from the surface and, especially, from a carpeted surface. The cylinder may be powered and rotated either by a dedicated motor, a motor shared with the suction fan of the vacuum cleaner or may be powered by the airflow of the vacuum cleaner. Accordingly, use of an agitator requires power and hence uses energy.

If the brush bar has a dedicated motor then this increases the cost of a vacuum cleaner. Furthermore, this motor may fail and, thereby increases the likelihood of faults occurring with the vacuum cleaner.

If the brush bar is powered by the fan motor then this requires a drive transfer mechanism to power the brush bar. Again, this increases the cost of the vacuum cleaner and also increases the likelihood of faults/problems occurring. Similarly, if the brush bar is powered by the airflow of the vacuum cleaner then this again requires additional apparatus which increases the costs and likelihood of failure. In addition, this also reduces the suction of the power generated in the cleaning head since some of the suction power will be lost due to the energy required to power the brush bar.

The agitation of carpet fibers is highly beneficial in the cleaning effectiveness of a vacuum cleaner due to the effectiveness of the action in releasing dust and debris from the carpet fibers to which they may be adhered.

It is an aim of the present invention to overcome at least one problem associated with the prior art whether referred to herein or otherwise.

### BRIEF SUMMARY OF THE INVENTION

According to a first aspect of the present invention there is provided a suction head for a vacuum cleaner, the suction head including at least one air bleed wherein the air bleed includes airflow inducing means, in the form of a shaped surface, in order to create an airflow directed substantially towards the surface to be cleaned.

Preferably the airflow inducing means includes vortex inducing means, in the form of a substantially frusto-conical shaped surface.

The axis of the vortex may form an angle with the surface to be cleaned in which the angle may be greater than 0° and preferably greater than 45° and more preferably greater that 80°.

Preferably, in use, the axis of the vortex is substantially perpendicular to the surface to be cleaned.

A central longitudinal axis of the airflow may form an angle with the surface to be cleaned in which the angle may be greater than 0° and preferably is greater than 45° and more preferably is greater than 80°.

Preferably, in use, a central longitudinal axis of the airflow is substantially perpendicular to the surface to be cleaned.

Preferably the suction head includes a plurality of air bleeds. Preferably each air bleed incorporates respective airflow inducing means and more preferably vortex inducing means. The suction head may also include auxiliary air bleeds which are of a different configuration to the plurality of air bleeds. For example, the auxiliary air bleeds may be linear air bleeds and may be located around sides of the suction head and may provide substantially planar airflow with the surface to be cleaned.

Preferably, in use, the axes of the vortices are each perpendicular to the surface to be cleaned.

Preferably the airflow (and preferably vortex) inducing means includes a substantially frusto-conical shaped surface. Preferably the frusto-conical shaped surface is tapered downwardly.

The airflow inducing means may be substantially tubular.

Preferably an upper cross-section of the frusto-conical shaped surface is substantially circular having a radius which is greater than the radius of the frusto-conical shaped surface at a lower cross-section. Preferably the radius of the circular cross-section of the frusto-conical shaped surface reduces (and preferably reduces at a uniform rate) downwardly from an upper end to a lower end.

Preferably the vortex inducing means (or airflow inducing means) includes an air inlet and air outlet.

Preferably the air inlet is arranged to induce vortex airflow within the vortex inducing means (or airflow inducing means).

Preferably the air inlet is arranged to direct the air inflow around a frusto-conical shaped surface of the vortex inducing means (or airflow inducing means).

Preferably the air inlet is arranged substantially tangentially relative to the frusto-conical shaped surface in order to direct the air substantially tangentially with the respect to the frusto-conical shaped surface.

Preferably the air outlet is arranged substantially centrally in the vortex inducing means (or airflow inducing means) and preferably directs the air generally outwardly from the vortex inducing means (or airflow inducing means).

Preferably the suction head includes an array of air bleeds.

Preferably the array of air bleeds is arranged such that the air inlets of the air bleeds are located on an upper surface of the suction head.

Preferably the air outlets of the air bleeds direct the air into a suction chamber within the suction head. The suction chamber may be defined by an upper wall and a peripheral wall which provides an open face for locating adjacent to a surface to be cleaned.

The air outlets of the air bleeds may be located on the upper wall of the suction chamber.

The air outlets of the air bleeds may include a projecting portion which projects downwardly into the suction chamber relative to the upper wall of the suction chamber. Alternatively, the air outlets of the air bleeds may be substantially flush with the upper wall of the suction chamber.

Preferably, the vortex inducing means (or airflow inducing means) is arranged to produce a vortex (or airflow) directed towards an apex. Preferably, in use, the apex is arranged to be located at the surface to be cleaned. For example, the apex may be arranged to locate within the carpet fibers of the carpet being cleaned and/or, for example, the apex may be arranged to locate on or adjacent to a hard surface being cleaned.

The air bleeds may be arranged substantially linearly across the width of the suction head. The suction head may include a first array or line of air bleeds and a second array or line of air bleeds. The air bleeds in the second array or line may be laterally offset from the air bleeds in the first array or line.

The suction head may include less than or equal to twenty arrays or lines of air bleeds.

Each array or line of air bleeds may include less than or equal to twenty air bleeds and may include less than or equal to ten air bleeds.

The upper wall of the suction chamber may be planar and may be arranged, in use, to be co-planar with the surface to be cleaned.

The upper wall of the suction chamber may be angled and, in particular, may include a first section that is angled downwardly from a central location to a first lateral side of the suction head and a second section that is angled downwardly from a central location to a second lateral side of the suction head.

The suction head may include a peripheral sealing member which may be selectively operatable. For example, when cleaning a carpeted surface or the like, the peripheral sealing member may not be required and may be moved to a non-operating position and whilst cleaning a hard surface or the like the peripheral sealing may be required and may be moved to an operating position. Preferably, the peripheral sealing member includes a brush member.

The airflow inducing means may include a substantially tubular surface (for example, a cylindrical section) which may have a uniform cross-section. The airflow inducing means may induce substantially linear airflow.

According to a second aspect of the present invention there is provided a vacuum cleaner including a suction head wherein the suction head includes at least one air bleed including airflow inducing means in order to create an airflow directed substantially towards the surface to be cleaned.

The airflow inducing means may include vortex inducing means.

The vacuum cleaner may be a cylinder type vacuum cleaner.

The vacuum cleaner may be an upright type vacuum cleaner.

The vacuum cleaner may be a hand held vacuum cleaner.

According to a third aspect of the present invention there is provided a method of agitating a surface to be cleaned including providing a suction head including a suction chamber having an open face to be located adjacent to a surface to be cleaned the method including forming an airflow directed substantially towards the surface to be cleaned.

The method may include forming a vortex airflow directed substantially towards the surface to be cleaned.

The method may include forming a plurality of airflows (or vortex airflows) directed substantially towards the surface to be cleaned.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a cross section of an embodiment of a suction head for a vacuum cleaner.

FIG. 2 is a bottom view of an embodiment of a suction head for a vacuum cleaner.

FIG. 3 is another side cross section of an embodiment of a suction head for a vacuum cleaner.

FIG. 4 is a partially cut away view of an embodiment of a suction head for a vacuum cleaner.

FIG. 5 is a front cross section of an embodiment of a suction head for a vacuum cleaner.

FIG. 6 is a front cross section of part of an embodiment of a suction head for a vacuum cleaner.

FIG. 7 is a perspective view of an embodiment of a part of an array of air bleeds for use in an embodiment of a suction head for a vacuum cleaner.

FIG. 8 is a front view of an embodiment of an array of air bleeds for use in a suction head of a vacuum cleaner.

FIG. 9 is a plan view of an embodiment of an array of air bleeds of an embodiment of a suction head for a vacuum cleaner.

FIG. 10 is a partially cut away view of an embodiment of a suction head for a vacuum cleaner.

FIG. 11a is a perspective view of vortex inducing means of an embodiment of an air bleed.

FIG. 11b is a plan view of vortex inducing means of an embodiment of an air bleed.

FIG. 11c is a side schematic view of vortex inducing means of an embodiment of an air bleed.

FIG. 12 is a bottom view of a second embodiment of a suction head for a vacuum cleaner.

FIG. 13 is a partially cut away plan view of a second embodiment of suction head for a vacuum cleaner.

FIG. 14 is a partially cut away front view of a second embodiment of a suction head for a vacuum cleaner.

FIG. 15 is a side cross-section of a second embodiment of a suction head for a vacuum cleaner.

FIG. 16a is a partially cut away plan view of a third embodiment of a suction head for a vacuum cleaner.

FIG. 16b is a bottom view of a third embodiment of a suction head for a vacuum cleaner.

FIG. 16c is a partially cut away front view of a third embodiment of a suction head for a vacuum cleaner.

FIG. 16d is a side cross-section of a third embodiment of a suction head for a vacuum cleaner.

FIG. 17a is a partially cut away plan view of a fourth embodiment of a suction head for a vacuum cleaner.

FIG. 17b is a bottom view of a fourth embodiment of a suction head for a vacuum cleaner.

FIG. 17c is a partially cut away front view of a fourth embodiment of a suction head for a vacuum cleaner.

FIG. 17d is a side cross-section of a fourth embodiment of a suction head for a vacuum cleaner.

FIG. 18a is a partially cut away plan view of a fifth embodiment of a suction head for a vacuum cleaner.

FIG. 18b is a bottom view of a fifth embodiment of a suction head for a vacuum cleaner.

FIG. 18c is a partially cut away front view of a fifth embodiment of a suction head for a vacuum cleaner.

FIG. 18d is a side cross-section of a fifth embodiment of a suction head for a vacuum cleaner.

FIG. 19a is a partially cut away plan view of a sixth embodiment of a suction head for a vacuum cleaner.

FIG. 19b is a bottom view of a sixth embodiment of a suction head for a vacuum cleaner.

FIG. 19c is a partially cut away front view of a sixth embodiment of a suction head for a vacuum cleaner.

FIG. 19d is a side cross-section of a sixth embodiment of a suction head for a vacuum cleaner.

FIG. 20a is a partially cut away plan view of a seventh embodiment of a suction head for a vacuum cleaner.

FIG. 20b is a bottom view of a seventh embodiment of suction head for a vacuum cleaner.

FIG. 20c is a partially cut away front view of a seventh embodiment of a suction head for a vacuum cleaner.

FIG. 20d is a side cross-section of a seventh embodiment of a suction head for a vacuum cleaner.

FIG. 21a is a partially cut away plan view of an eighth embodiment of a suction head for a vacuum cleaner.

FIG. 21b is a bottom view of an eighth embodiment of a suction head for a vacuum cleaner.

FIG. 21c is a partially cut away front view of an eighth embodiment of a suction head for a vacuum cleaner.

FIG. 21d is a side cross-section of an eighth embodiment of a suction head for a vacuum cleaner.

FIG. 22a is partially cut away plan view of a ninth embodiment of a suction head of a vacuum cleaner.

FIG. 22b is a bottom view of a ninth embodiment of a suction head for a vacuum cleaner.

FIG. 22c is a partially cut away front view of a ninth embodiment of a suction head for a vacuum cleaner.

FIG. 22d is a side cross-section of a ninth embodiment of a suction head for a vacuum cleaner.

FIG. 23a is a partially cut away plan view of a tenth embodiment of a suction head for a vacuum cleaner.

FIG. 23b is a bottom view of a tenth embodiment of a suction head for a vacuum cleaner.

FIG. 23c is a partially cut away front view of a tenth embodiment of a suction head for a vacuum cleaner.

FIG. 23d is a side cross-section of a tenth embodiment of a suction head for a vacuum cleaner.

FIG. 24a is a partially cut away plan view of an eleventh embodiment of a suction head for a vacuum cleaner.

FIG. 24b is a bottom view of an eleventh embodiment of a suction head for a vacuum cleaner.

FIG. 24c is a partially cut away front view of an eleventh embodiment of a suction head for a vacuum cleaner.

FIG. 24d is a side cross-section of an eleventh embodiment of a suction head for a vacuum cleaner.

FIG. 25 is a perspective view of another embodiment of vortex inducing means for use in an air bleed of a suction head for a vacuum cleaner.

FIG. 26a is a plan view of a further embodiment of vortex inducing means including powder introducing means, in the form of an inlet, for use in an air bleed of a suction head for a vacuum cleaner.

FIG. 26b is a side schematic view of a further embodiment of vortex inducing means including powder introducing means, in the form of an inlet, for use in an air bleed of a suction head for a vacuum cleaner.

FIG. 27a is a plan view of a yet further embodiment of vortex inducing means including fluid introducing means, in the form of an inlet, for use in an air bleed of a suction head for a vacuum cleaner.

FIG. 27b is a side schematic view of a yet further embodiment of vortex inducing means including fluid introducing means, in the form of an inlet, for use in an air bleed of a suction for a vacuum cleaner.

Like reference numbers and designations in the various drawings indicated like elements.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

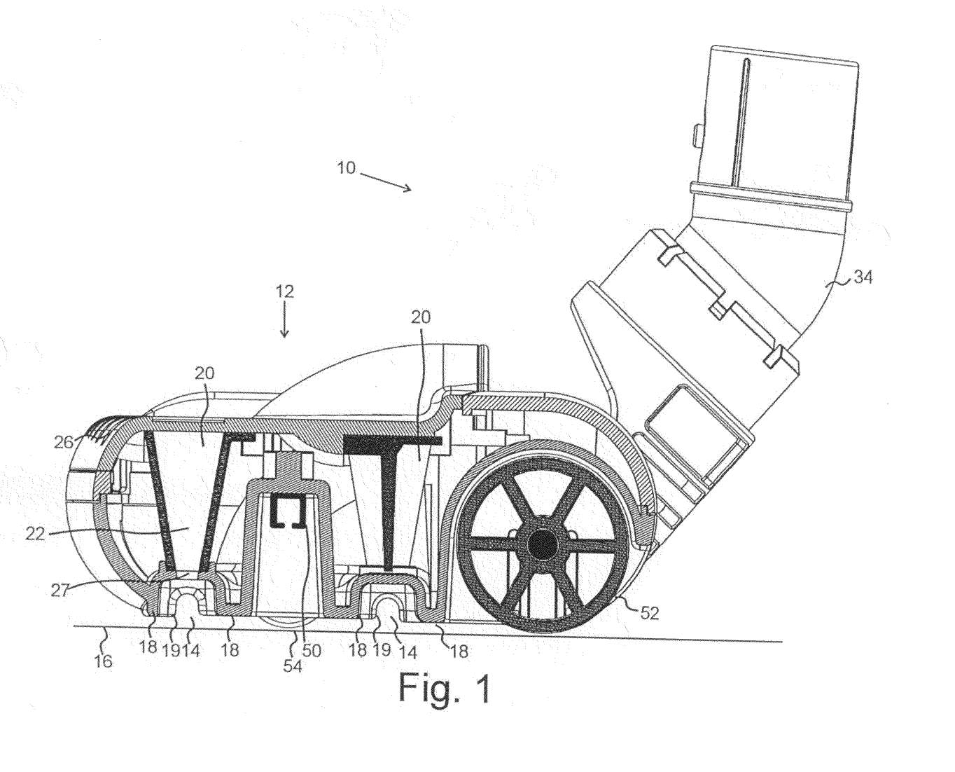

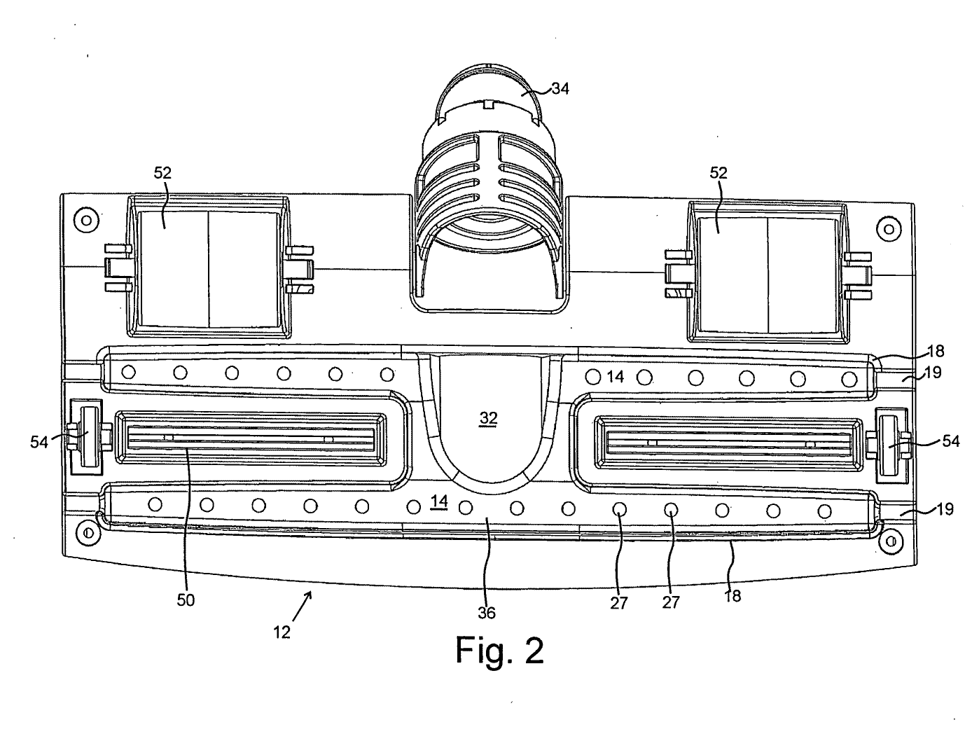

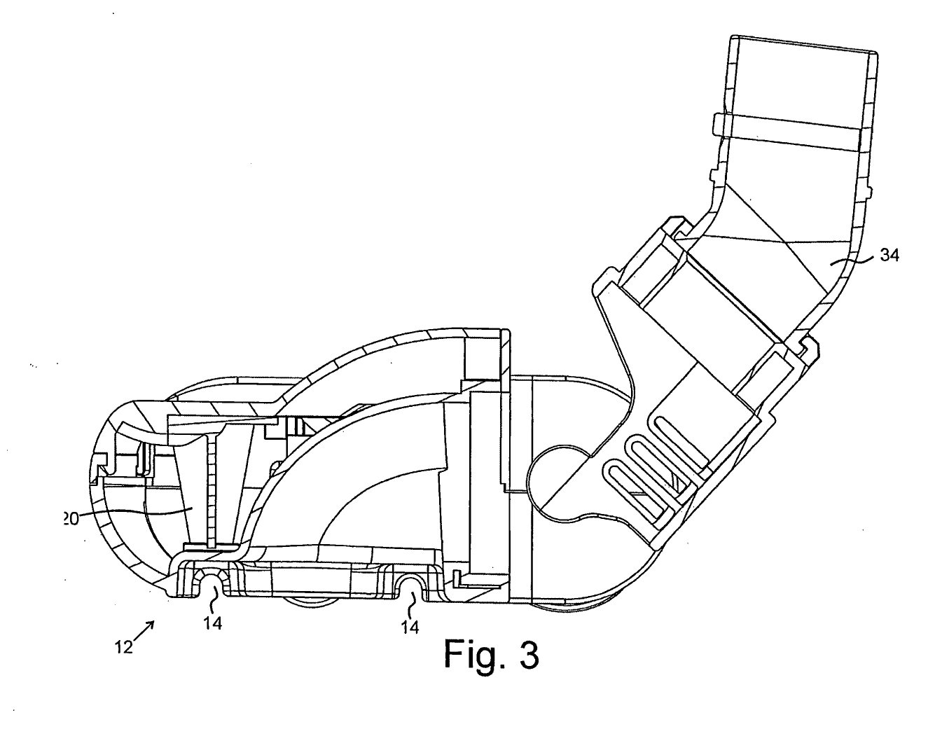

As shown in FIGS. 1 to 4, an attachment for a vacuum cleaner 10 includes a cleaning head or suction head 12 which includes a suction chamber 14 to create and contain a region of relatively low pressure adjacent to a surface 16 to be cleaned. As previously explained, the suction head 12 includes a peripheral member 18 which is arranged to locate against the surface 16. The peripheral member 18 is required to provide an effective suction chamber 14. However, on certain surfaces, a peripheral member 18 may form a very effective seal which prevents the suction head 12 from being manually moved over the surface 16. Accordingly, air inlet means (air bleeds 20) are required for the suction head 12. In the embodiment shown in FIGS. 1 to 4, the suction head 12 includes side bleeds 19 which allow some air to enter into the suction chamber 14. This air flows substantially co-planar with the surface 16 to be cleaned. The suction head 12 induces a brush blade holder 50 which is arranged to retain a brush blade to aid the cleaning of the surface 16 and to help disturb and remove dust and debris. The suction head also includes rear wheels 52 and front wheels 54 to enable the suction head 12 to easily travel over a surface.

In the preferred embodiment, the air inlet means includes air bleeds 20 which produce a cyclonic airflow 28 as the atmospheric air passes through the air bleeds 20 into the suction head 12. This cyclonic airflow 27 is arranged to be directed towards the surface 16 to be cleaned and is arranged to travel (or penetrate) into the surface 16 to be cleaned. This cyclonic airflow is arranged to agitate the surface 16 to be cleaned and to, thereby, increase the efficiency of the vacuum cleaner 10. In an alternative embodiment, the air bleeds include airflow inducing means which may enable substantially generally linear airflow through the suction head 12 into the suction chamber 14. For example, the air bleeds 20 may include tubular portions which induce the substantially linear airflow into the suction chamber 14.

As shown in FIG. 11a, FIG. 11b and FIG. 11c, in the preferred embodiment the airflow creates a cyclone directed towards an apex 30 wherein the apex 30 is arranged to be located below the level of the upper level of the surface 16 being cleaned. For example, the apex 30 of the cyclonic airflow 28 is arranged to locate within the fibers of a carpet such that the cyclonic airflow 28 agitates the fibers of the carpet and is arranged to disturb and disrupt dirt, debris and dust within the carpet. Accordingly, the cyclonic bleeds 20 form the dual function of providing the essential air bleeds for the suction head 12 whilst also providing the function of a surface agitator.

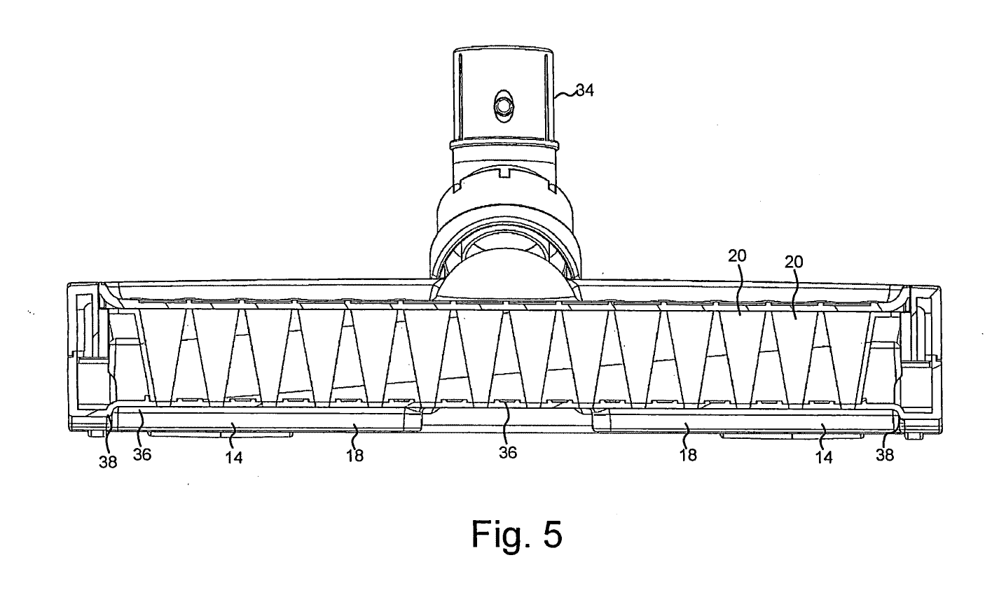

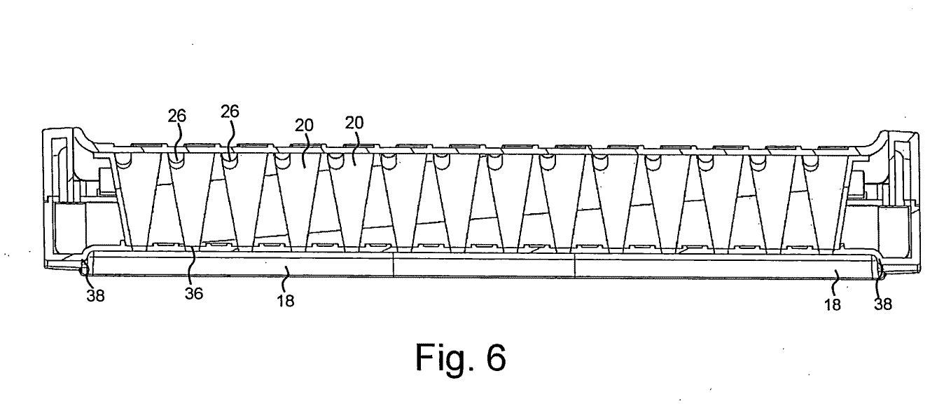

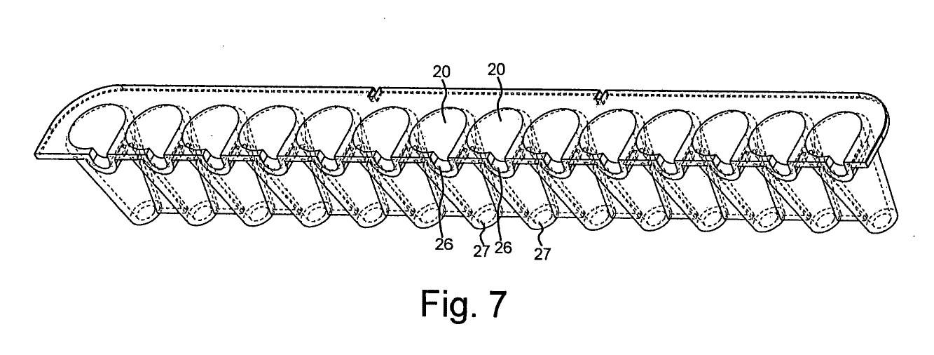

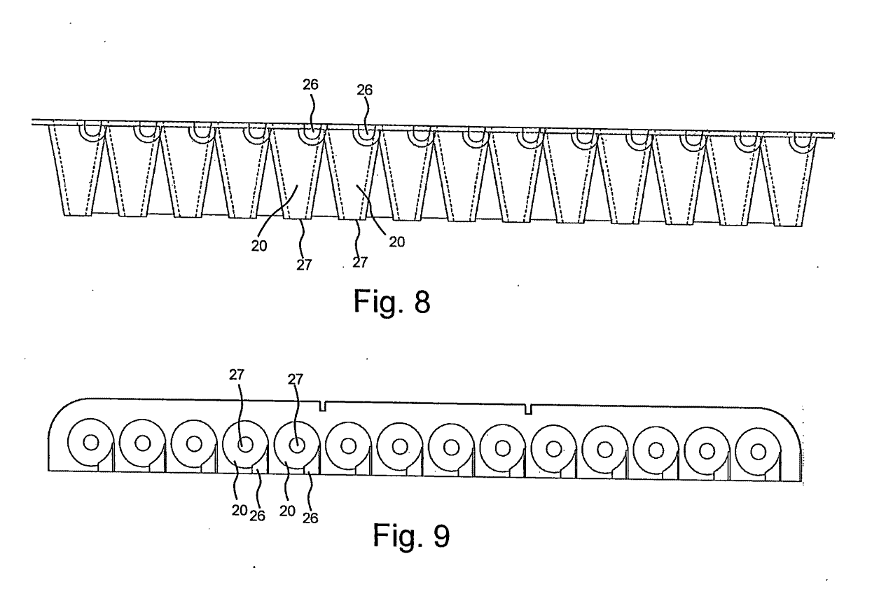

The suction head 12 includes a plurality of cyclonic air bleeds 20, as shown in FIGS. 5 to 10.

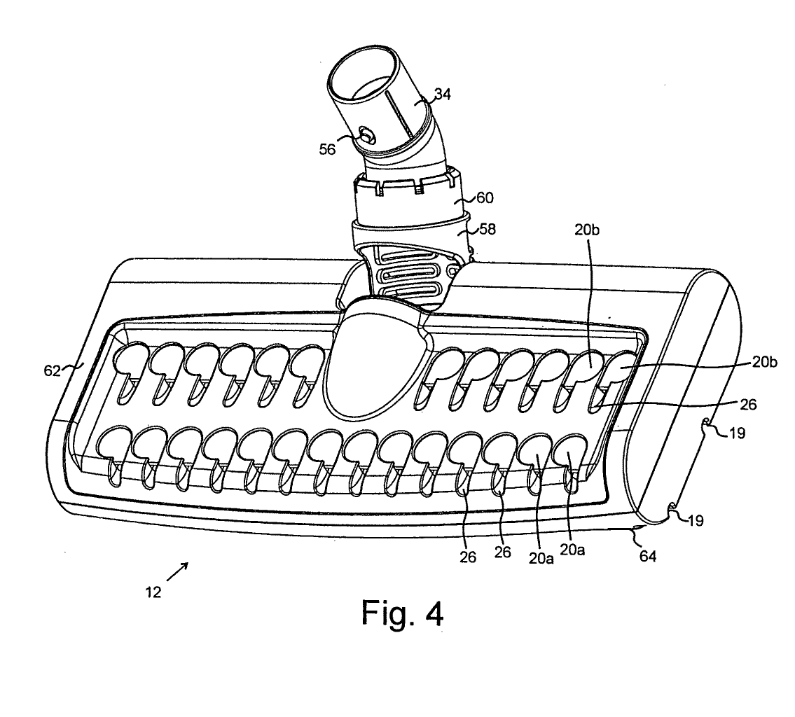

The cyclonic air bleeds 20 are arranged in at least one array and in the preferred embodiment the suction head 12 includes two linear arrays of cyclonic air bleeds 20. The suction head 12 includes a first linear array of first cyclonic air bleeds 20a which extends across the width of the suction head 12 and a second linear array of second cyclonic air bleeds 20b which extends across the width of the suction head 12. The second array is arranged to be located behind the first array. The second cyclonic air bleeds 22a in the second array are linearly offset from the first cyclonic air bleeds located in the first array, as shown in FIG. 2 and FIG. 4. This offset configuration increases the surface area which is subjected to agitation by the cyclones 28 created by the cyclonic air bleeds 20, for example, a suction head 12 is generally moved forwards and backwards and since the cyclones are offset then this reduces the likelihood of an area of the surface 16 not being subjected to direct agitation.

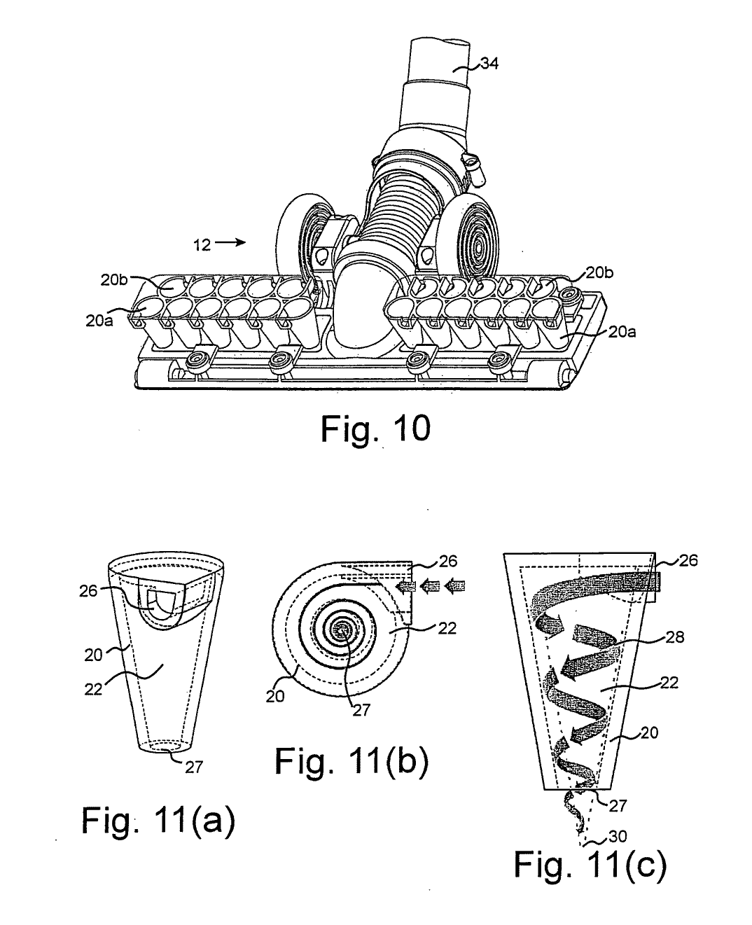

The arrays of cyclonic bleeds 20 may be arranged around the central connecting conduit 34 as shown in FIG. 10. Alternatively the first array of first cyclonic air bleeds 20a may be continuous whilst the second array of second cyclonic air bleed 20b may be arranged either side of the conduit 34, as shown in FIG. 4. Each cyclonic air bleed 20 includes a chamber 22 including a frusto-conical surface 24 and has a tangential air inlet 26, as shown in FIG. 11a, FIGS. 11b and 11c. Each cyclonic air bleed 20 includes an outlet 27 which is located centrally at the lower end and directs the air flow outwardly into the suction chamber 14. In use, air enters through the tangential air inlet 20 and is drawn through the air bleed 20 by travelling around the frusto-conical surface 24 in a generally spiral or helical pattern 28 as shown in FIG. 11c. Accordingly, the air flows downwardly in a helical manner with a decreasing diameter such that the airflow accelerates and travels towards an apex 30 (shown schematically in FIG. 11c). The air at the apex 30 is arranged to disturb and disrupt the carpet fibers in order to disturb and release dust and debris and the air then travels through the suction chamber 14 and through an outlet 32 whilst also carrying the dust and debris. As with conventional vacuum cleaners, the airflow including the dust and debris then travels through a conduit 34 and into a dust collecting chamber where the dust and debris is collected. The dust collecting chamber may include a conventional system or may include a cyclonic system. Once the dust and debris has been deposited or at least a significant portion thereof, the air then flows back to the external atmosphere.

The suction chamber 14 is defined by an upper wall 36 and at least one peripheral wall 38. The outlets 27 of the cyclonic air bleeds 20 are located on the upper wall 36. In the preferred embodiment, as shown in FIG. 2, the suction chamber 14 include a generally “H” shape such that the first array of cyclonic air bleeds 20a are located in a first linear section of the suction chamber 14 and the second array of cyclonic air bleeds 20b are located in a second linear section of the suction chamber and the two sections are connected centrally where the outlet 32 to the conduit 34 is located. This reduces the surface area of the effective suction chamber 14 and thereby relatively increases the suction power. As shown in FIG. 5, the upper wall 36 of the suction chamber 14 is planar and is arranged, in use, to be co-planar with the surface 16 being cleaned. In addition, the suction chamber 14 may also incorporate auxiliary air bleeds 19 which are located around the peripheral wall 38 of the suction chamber 14. In the preferred embodiment, as shown in FIGS. 1 to 5, the outlets 27 of the cyclonic air bleeds 20 are arranged to be flush with the upper wall 36 of the suction chamber 14.

The suction head 12 incorporates two main air paths which both share a central aperture 32 for suction. On each air path there are a series of vortex cones which terminate within the air path. In between each air path there is a brush to further help with the floor surface agitation. The floor head also has side bleeds 19 to help with wall/side pick up. The suction floor head also incorporates a flexible hose linking the main aperture 32 and the pivoting arm. This allows flexibility and improved sealing of the air path. The main conduit for the vacuum cleaner is connected to a suction head 12 by a telescopic tube clip 56 and the suction head 12 includes a pivoting arm 58 and a pivoting joint 60. The suction head 12 includes and is constructed from a top clamshell 62 and a bottom clamshell 64.

It can be seen that the present invention provides an improved cleaning head 12 for a vacuum cleaner 10 which includes agitation means which is produced efficiently and without any additional moving parts which could increase the risk of failure. The present invention achieves this advantage whilst also being energy efficient. It is appreciated that the present invention may be incorporated in a cleaning head having a conventional brush bar agitator such that the action of the cyclonic bleeds 20 will complement the action of the brush bar.

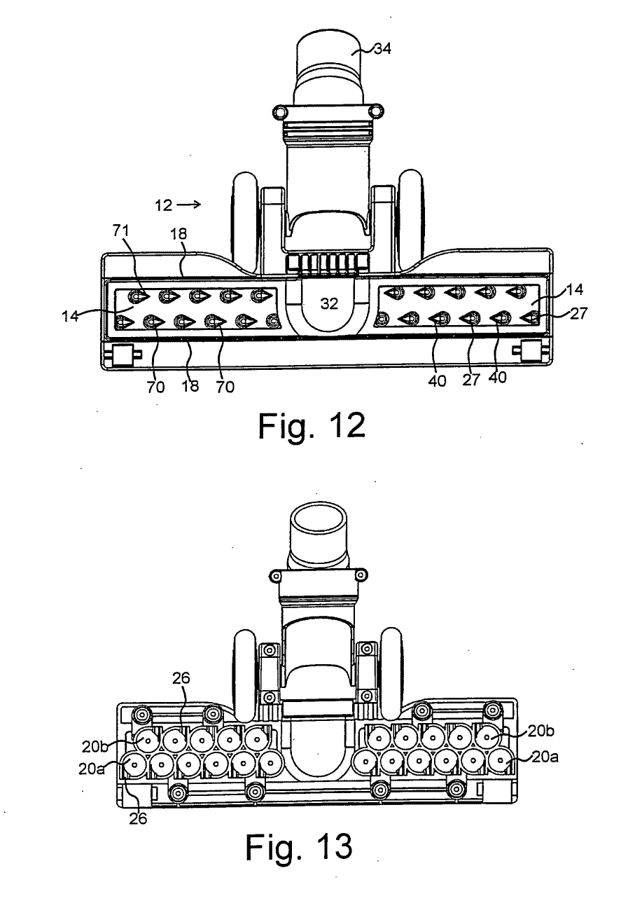

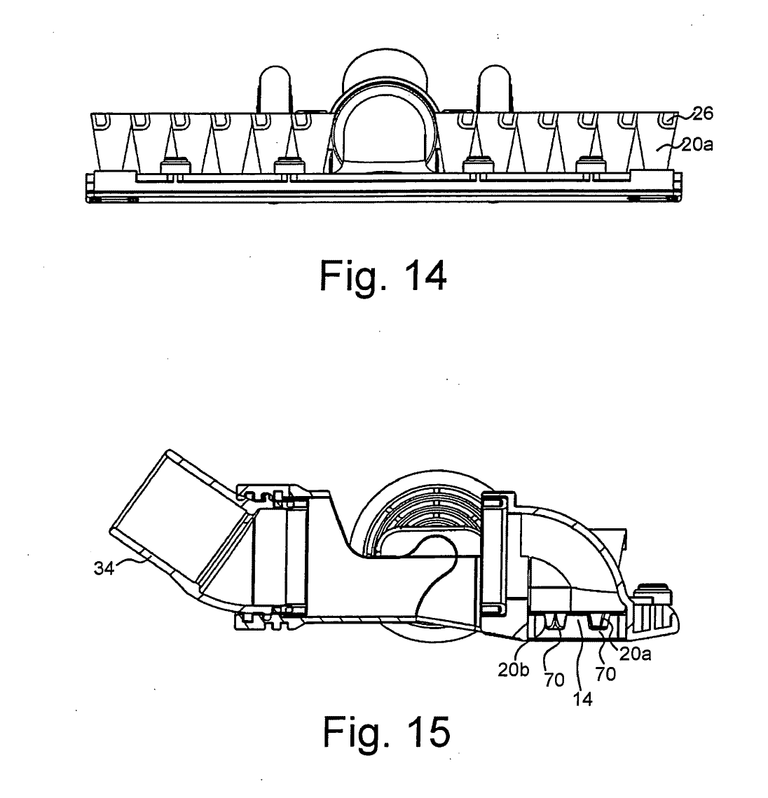

As shown in FIG. 12 to FIG. 15, a second embodiment of a suction head 12 for a vacuum cleaner 10 includes a first array of first cyclonic air bleeds 20a and a second array of second cyclonic air bleeds 20b. The outlets 27 of each cyclonic includes a projecting portion 70 which projects downwardly from the upper wall 36 of the suction chamber 14. These projecting portions 70 effectively form pips and in this embodiment the pips are teardrop shaped with the apex 71 of the teardrop being located towards the outlet 32. This tear drop shape helps to improve the aerodynamics of the suction head 12 and prevents or inhibits any debris being built up and collected on the dead air side of the pips. This also allows the vortex to terminate closer to the floor surface 16 and therefore creates greater agitation.

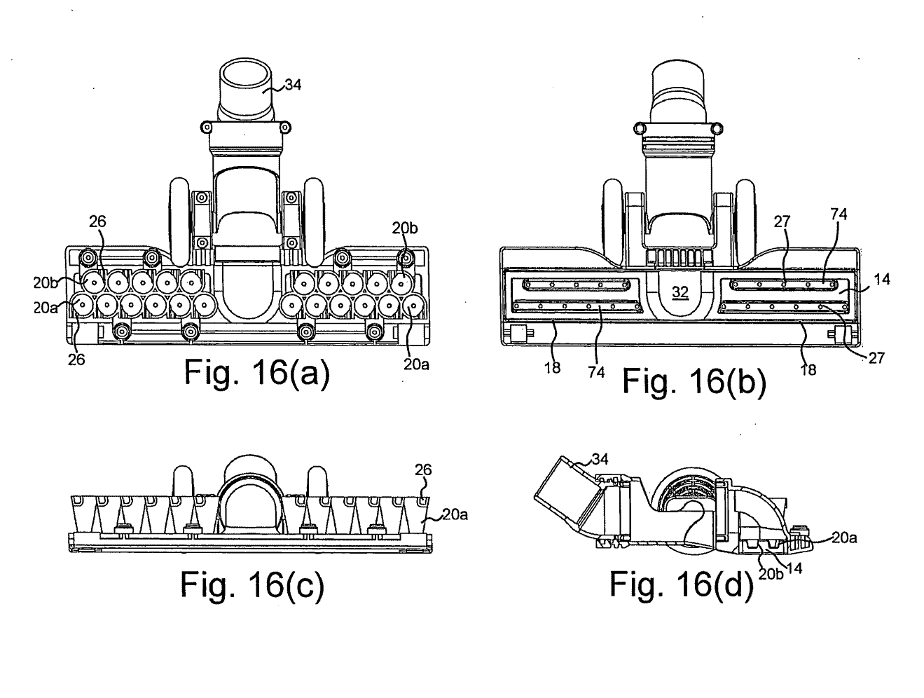

FIG. 16a to FIG. 16d shows a third embodiment of a suction head 12 for a vacuum cleaner. The outlets 27 of the cyclonic air bleeds 20a, 20b are located on a raised bar portion 74 which extends downwardly from the upper wall 36 of the suction chamber 14. The aim of the bar 74 is to prevent build up of debris and to create a clean air path within the suction chamber 14.

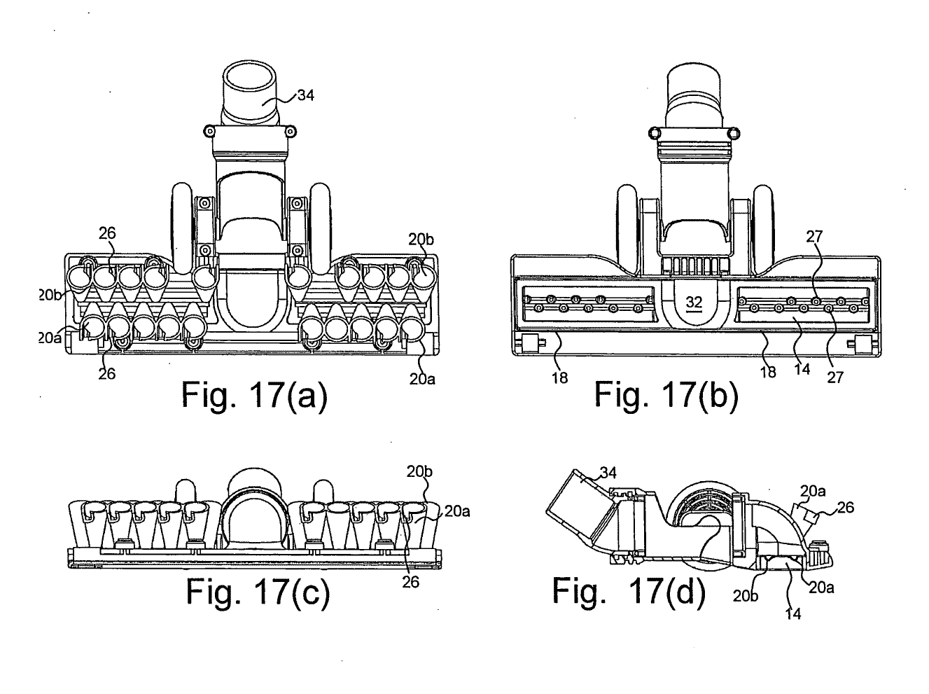

A fourth embodiment of a suction head 12 for a vacuum cleaner 10 is shown in FIG. 17a to FIG. 17d. In this embodiment, the suction head 12 includes a first array of first cyclonic air bleeds 20a which are directed and angled rearwardly on the suction head 12. In addition, the suction head 12 includes a second array of second cyclonic air bleeds 20b which are directed forwardly and angled downwardly on the suction head 12. This angled design provides a single linear arrangement of the apexes of the cyclonic air bleeds 20a, 20b in both the arrays and, thereby, aims to provide an even agitation of the surface to be cleaned.

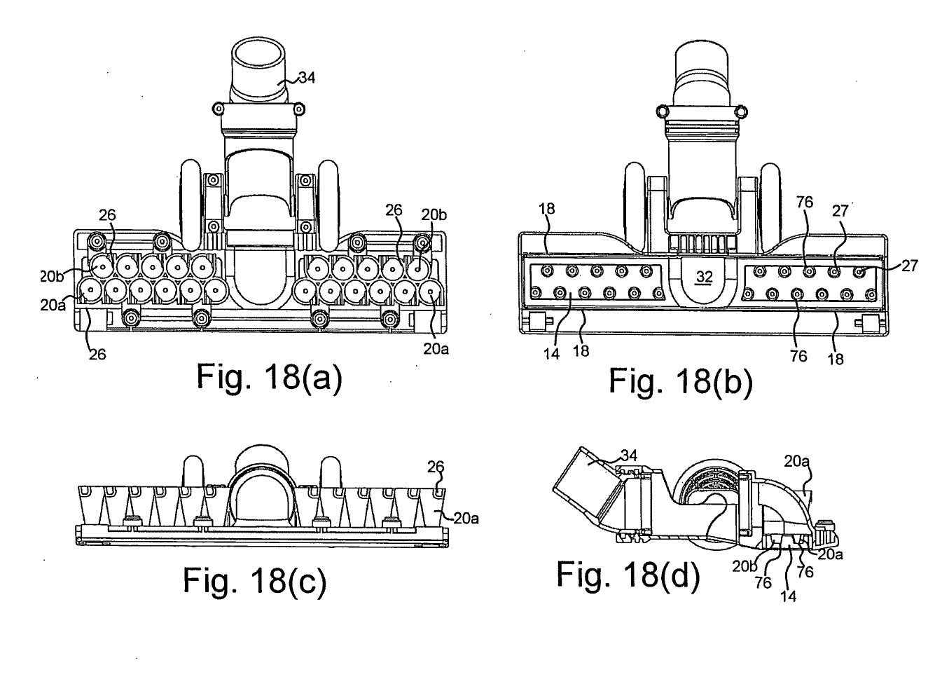

A fifth embodiment of a suction head 12 for a vacuum cleaner 10 is shown in FIG. 18a to FIG. 18b. In this embodiment, the cyclonic air bleeds 20 have projecting portions 76 which extend downwardly from the upper wall 36 of the suction chamber 14. The projection portions 76 or pips are generally circular and enable the vortex to terminate closer to the floor surface 16 and thereby create greater agitation.

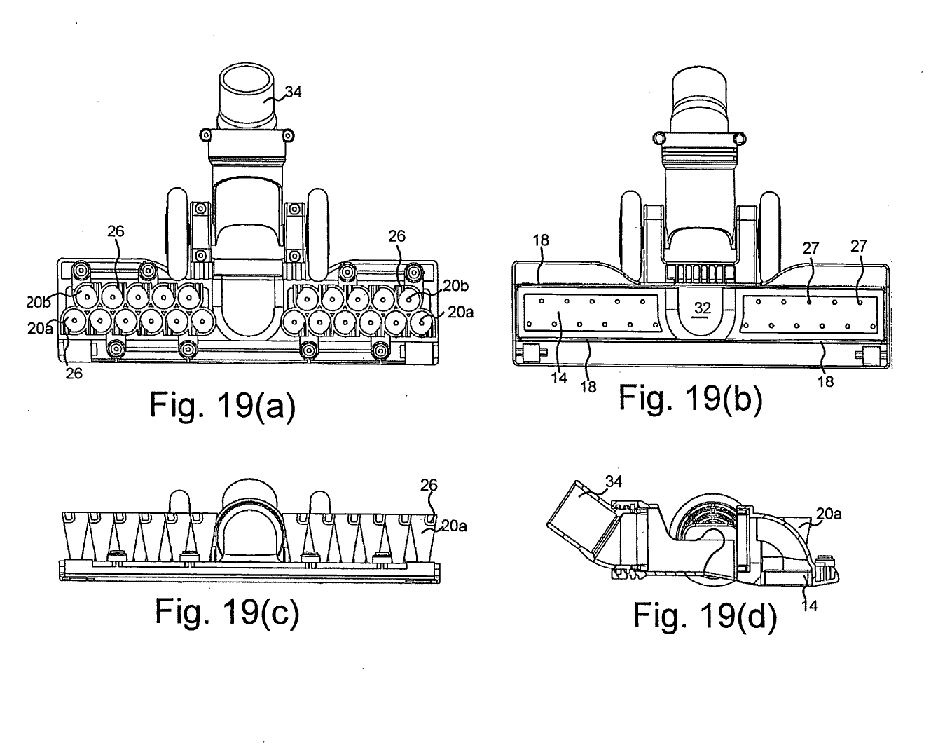

A sixth embodiment of the present invention is shown in FIG. 19a to FIG. 19d. In this embodiment the outlets 27 of the cyclonic air bleeds 20a, 20b are arranged to be flush with the upper wall 36 of the suction chamber 14. The aim of this arrangement is to prevent obstacles or debris and dirt within the suction chamber 14 wherein such dirt and debris may build up within the suction chamber 14 and reduce the effectiveness of the vacuum cleaner 10.

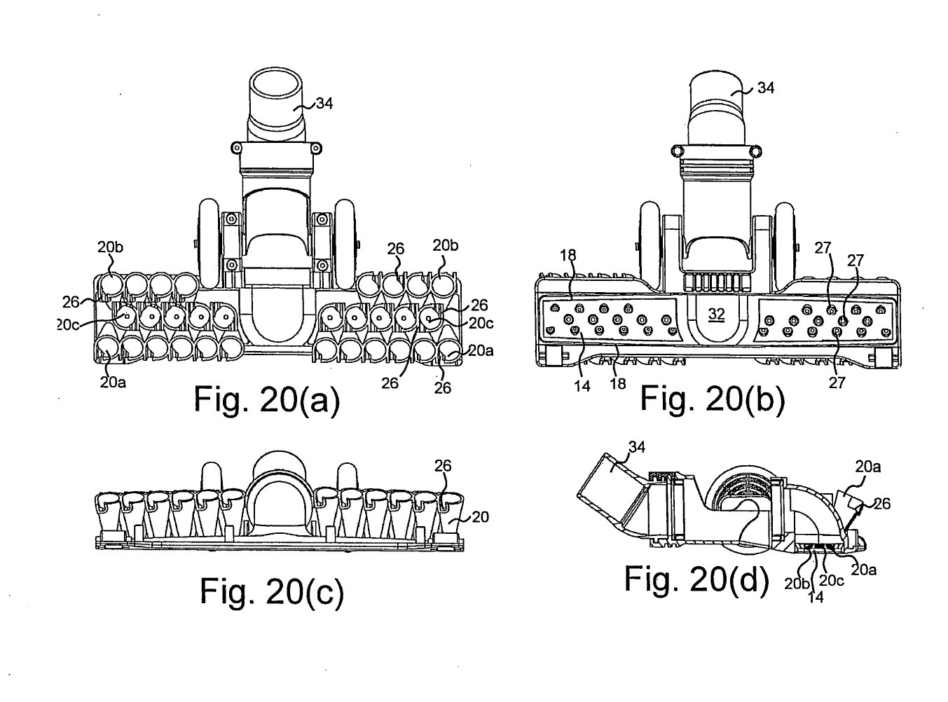

A seventh embodiment of a suction head 12 for a vacuum cleaner 10 is shown in FIG. 20a to FIG. 20d. In this embodiment, the suction head 12 includes a first array of first cyclonic air bleeds 20a, a second array of second cyclonic air bleeds 20b and also a third array of third cyclonic air bleeds 20c. The third array of cyclonic air bleeds 20c is located in between the first array of cyclonic air bleeds 20a and the second array of a second cyclonic air bleed 20b. In addition, the first array of first cyclonic air bleeds 20a are generally angled rearwardly such that the apexes of the cyclones created by the first cyclonic air bleeds 20a generally coincide with the apexes of the cyclone as created by the third array of third cyclonic air bleeds 20c. Similarly, the second cyclonic air bleeds 20b in the second array are angled downwardly and forwardly such that the apexes of the cyclones created in the second cyclonic air bleeds 20b coincide with the apexes of the cyclones created by both the first cyclonic air bleeds 20a and the third cyclonic air bleeds 20c. It can be seen that all of the cyclonic air bleeds 20a, 20b, 20c are laterally offset along the suction head in order to provide a comprehensive linear arrangement of apexes to agitate the surface to be cleaned.

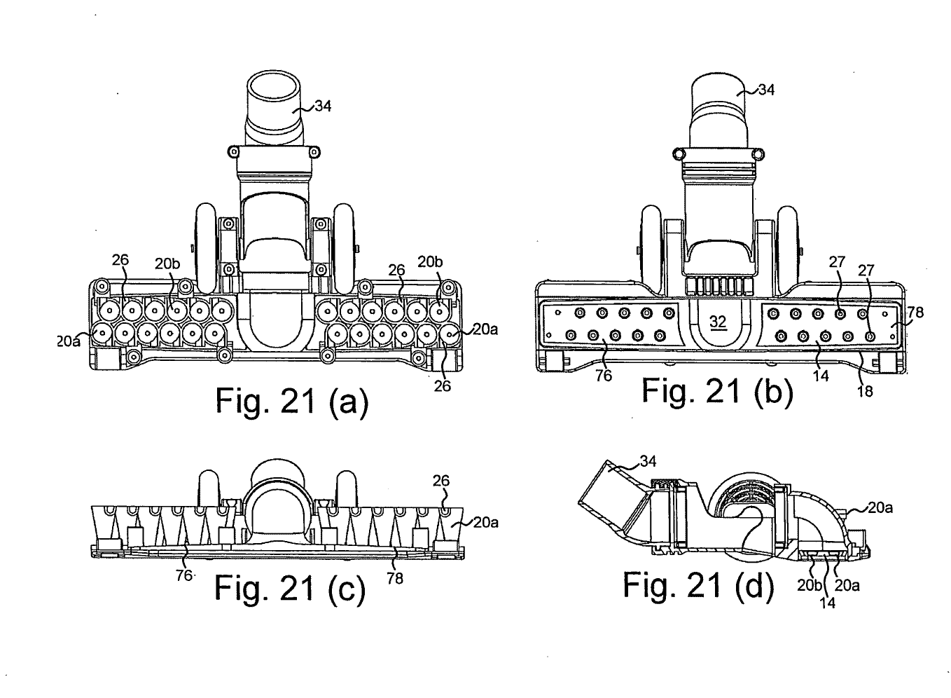

An eighth embodiment of the present invention is shown in FIG. 21a to FIG. 21d. In this embodiment, the upper walls 36 of the suction head 14 is angled downwardly from the central position. In particular, the upper wall of the suction chamber 14 includes a first lateral section 76 which extends downwardly from the central outlet 32 to a first lateral side and a second lateral section 78 extends downwardly from the central outlet 32 to a second lateral side. In this embodiment, the cyclonic air bleed 20 include circular pips which project downwardly from the upper wall 36. In particular, as the pips located further away from the central outlet 32, the projecting distance decreases until the outlets 27 of the cyclonic air bleeds 20a, 20b located at the lateral side of the suction head 12 are flush with the upper wall 36 of the suction chamber 14. Accordingly, the vortex terminates inside of the air path with pips supporting the end of the vortex cone. This allows the vortex to terminate closer to the floor surface and therefore creates greater agitation.

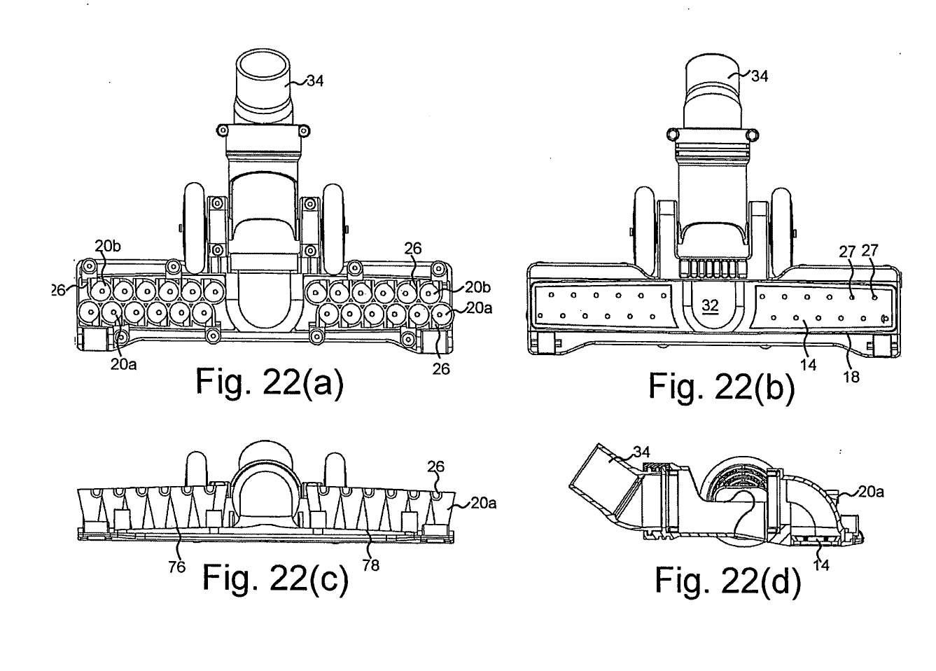

A ninth embodiment of a suction head 12 for use with in a vacuum cleaner 10 is shown in FIG. 22a to FIG. 22d. As previously described, the upper wall 36 of the suction chamber 14 is angled downwardly from a central location. However, in this embodiment, the cyclonic air bleeds 20a, 20b do not include pips but the outlets 27 of the cyclonic air bleeds 20a, 20b are substantially flush with the two sections 76, 78 of the upper wall 36 of the suction chamber 14. Accordingly, the vortex terminates flush with the air path so that there are no obstacles for debris and dirt to build up against.

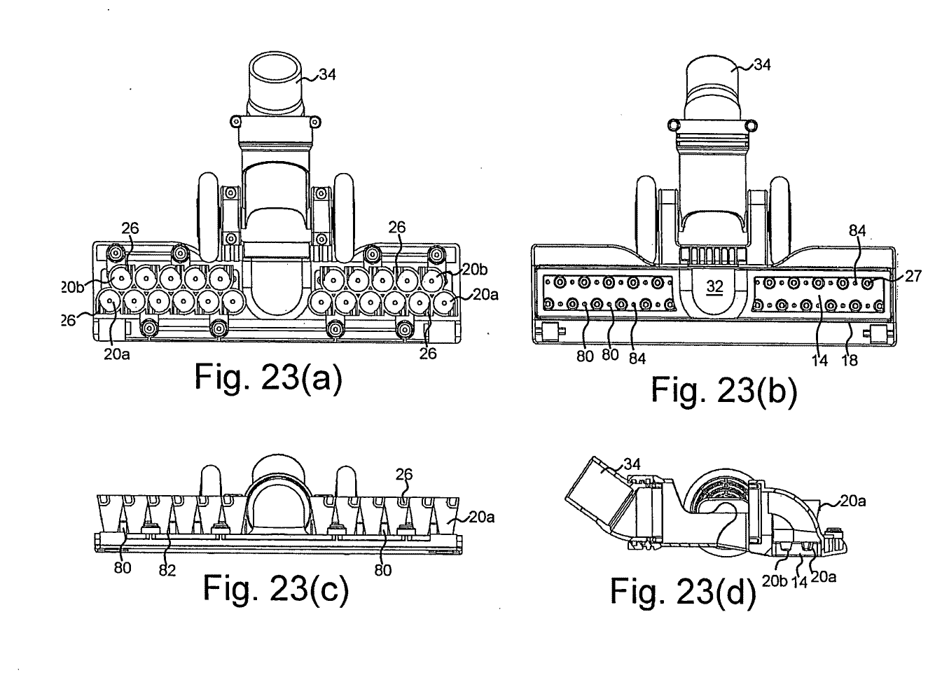

A tenth embodiment of a suction head 12 for a vacuum cleaner 10 is shown in FIG. 23a to FIG. 23d. In this embodiment, the suction head 12 includes extra linear air bleeds 80 in between the vortexes. In particular, the linear air bleeds 80 include an air inlet 82 where air from the atmosphere is drawn in to the suction chamber 14. The linear air bleeds 80 include air outlets 84 where the air is introduced into the suction chamber 14. These outlets 84 are located between the air outlets 27 for the cyclonic air bleeds 20a, 20b. In this embodiment, the cyclonic air bleeds 20a, 20b include circular pips. In particular, the vortex terminates inside of the air path with pips supporting the end of the vortex cone. This allows the vortex to terminate closer to the floor surface and therefore creates greater agitation. The linear air bleeds 80 incorporated in between the vortex cones also helps with the agitation. In this embodiment, the upper wall of the suction chamber is arranged to be substantially co-planar with the surface 16 to be cleaned.

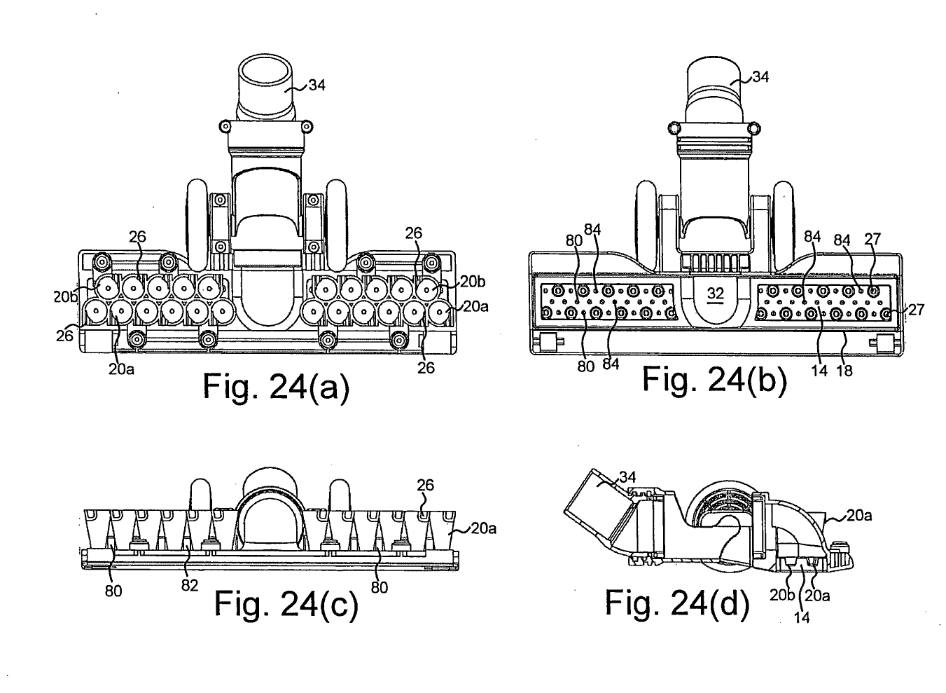

An eleventh embodiment of a suction head 12 for a vacuum cleaner 10 is shown in FIG. 24a to FIG. 24d. In this embodiment, the suction head 12 includes linear air bleeds 80 in order for air to be introduced into the suction chamber 14 to supplement that supplied by the cyclonic air bleeds 20. Each linear air bleed 80 includes an air inlet and an air outlet 84. The air outlets 84 which introduce the air into the suction chamber 14 are located in between adjacent air outlets 27 cyclonic of air bleeds 20a, 20b. In addition, the suction head 12 includes a linear row of linear air bleed outlets 84 located between the first array of first cyclonic air bleeds 20a and the second array of second cyclonic air bleeds 20b. In this embodiment the vortex terminates inside of the air path with pips supporting the end of the vortex cone. This allows the vortex to terminate closer to the floor surface and therefore creates greater agitation.

In addition, the upper wall 36 of the suction chamber 14 is arranged to be substantially co-planar with the surface 16 to be cleaned.

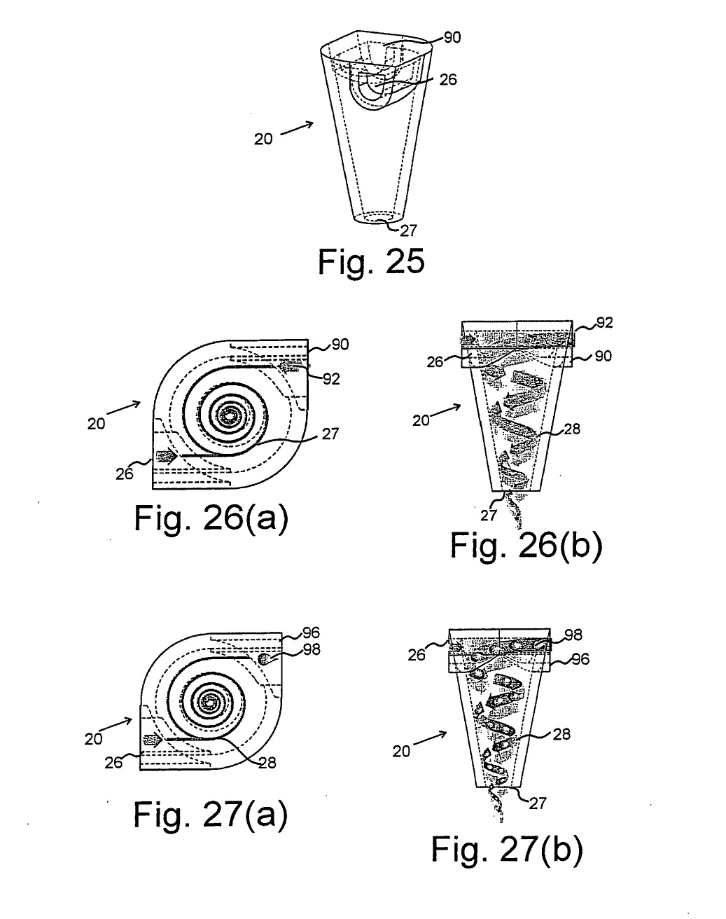

In further embodiments of the present invention, the cyclonic air bleeds 20 include fluid introducing means whereby liquids or powders etc can be introduced into the cyclonic airflow path 27 in order to supplement the cleaning function of the suction head 12 as shown in FIG. 25.

As shown in FIG. 26a and FIG. 26b, the cyclonic air bleed 20 includes an air inlet 26 and a powder introducing inlet 90. The powder introducing inlet 90 is arranged tangentially with the respect to the frusto-conical surface such that the powder 92 is drawn into the cyclonic airflow 27. The powder inlet 90 is arranged to be located 180° offset relative to the air inlet 26.

Similarly, the cyclonic air bleed 20 may include a liquid introducing means as shown in FIG. 27a and FIG. 27b. As with the powder introducing means, the liquid introducing means includes a liquid inlet 96 whereby a liquid 98 and, in particular, droplets of liquid 98 or an atomized liquid are drawn into the cyclonic airflow 28 within the frusto-conical surface 22 through a liquid inlet 96.

There are various methods in which the vortex technology can be utilized in household cleaning. The aforementioned methods and apparatus can be used to utilize air in helping with surface agitation. The main method involves drawing in air tangentially to the vortex cone. Due to the geometry, the cone air is encouraged to spin around the inside which thereby speeds up the velocity and peaks at the bottom of the cone which then agitates the surface to be cleaned. As mentioned above, there can be means to control the introduction of a powder into a second air duct at the top of the vortex cone. The powder can be perfumed or antibacterial depending on the purpose/application. Similarly, a liquid could be fed into the vortex cone in a controlled manner. The liquid would be carried in the air which would terminate within the carpet fibers. Depending upon the application, the liquid could be perfumed, antibacterial/cleaning solution.

One or more embodiments of the present invention have been described. Nevertheless, it will be understood that various modifications may be made without departing from the spirit and scope of the invention. Accordingly, other embodiments are within the scope of the following claims.

What is claimed is:

1. A suction head for a vacuum cleaner, the suction head comprising at least one air bleed wherein the air bleed includes airflow inducing means in order to create an airflow directed substantially towards a surface to be cleaned within a suction chamber, and wherein the airflow inducing means includes vortex inducing means.

2. A suction head for a vacuum cleaner according to claim 1, in which, in use, the axis of the vortex is substantially perpendicular to the surface to be cleaned.

3. A suction head for a vacuum cleaner according to claim 1, comprising a plurality of air bleeds.

4. A suction head for a vacuum cleaner according to claim 3 in which each air bleed incorporates respective vortex inducing means.

5. A suction head for a vacuum cleaner according to claim 4 in which, in use, the axes of the vortices are each perpendicular to the surface to be cleaned.

6. A suction head for a vacuum cleaner according to claim 1, in which the airflow inducing means includes a substantially frusto-conical shaped surface.

7. A suction head for a vacuum cleaner according to claim 6 in which the frusto-conical shaped surface is tapered downwardly.

8. A suction head for a vacuum cleaner according to claim 7 in which an upper cross-section of the frusto-conical shaped surface is substantially circular having a radius which is greater than the radius of the frusto-conical shaped surface at a lower cross-section.

9. A suction head for a vacuum cleaner according to claim 1, in which the airflow inducing means includes an air inlet and air outlet.

10. A suction head for a vacuum cleaner according to claim 9 in which the air inlet is arranged to induce vortex airflow within the airflow inducing means.

11. A suction head for a vacuum cleaner according to claim 10, in which the air inlet is arranged to direct the air inflow around the frusto-conical shaped surface of the airflow inducing means.

12. A suction head for a vacuum cleaner according to claim 11, in which the air inlet is arranged substantially tangentially relative to the frusto-conical shaped surface in order to direct the air substantially tangentially with the respect to the frusto-conical shaped surface.

13. A suction head for a vacuum cleaner according to claim 9, in which the air outlet is arranged substantially centrally in the airflow inducing means.

14. A suction head for a vacuum cleaner according to claim 13 in which the air outlet directs the air generally outwardly from the airflow inducing means.

15. A suction head for a vacuum cleaner according to claim 1, in which the suction head includes an array of air bleeds.

16. A suction head for a vacuum cleaner according to claim 15, in which the array of air bleeds is arranged such that the air inlets of the air bleeds are located on an upper surface of the suction head.

17. A suction head for a vacuum cleaner according to claim 1, in which the suction chamber is defined by an upper wall and a peripheral wall which provides an open face for locating adjacent to a surface to be cleaned.

18. A suction head for a vacuum cleaner according to claim 17, in which the air bleeds have air outlets which are located on the upper wall of the suction chamber.

19. A suction head for a vacuum cleaner according to claim 1, in which the air outlets of the air bleeds include a projecting portion which projects downwardly into the suction chamber relative to the upper wall of the suction chamber.

20. A suction head for a vacuum cleaner according to claim 1, in which the air outlets of the air bleeds are substantially flush with the upper wall of the suction chamber.

21. A suction head for a vacuum cleaner according to claim 1, in which the airflow inducing means is arranged to produce an airflow directed towards an apex.

22. A suction head for a vacuum cleaner according to claim 21 in which, in use, the apex is arranged to be located at the surface to be cleaned.

23. A suction head for a vacuum cleaner according to claim 3, in which the air bleeds are arranged substantially linearly across the width of the suction head.

24. A suction head for a vacuum cleaner according to claim 1, in which the suction head includes a first array or line of air bleeds and a second array or line of air bleeds.

25. A suction head for a vacuum cleaner according to claim 24 in which the air bleeds in the second array or line are laterally offset from the air bleeds in the first array or line.

26. A suction head for a vacuum cleaner according to claim 1, in which the upper wall of the suction chamber is planar.

27. A suction head for a vacuum cleaner according to claim 26, in which the upper wall of the suction chamber is arranged, in use, to be co-planar with the surface to be cleaned.

28. A suction head for a vacuum cleaner according to claim 1, in which the upper wall of the suction chamber is angled.

29. A suction head for a vacuum cleaner according to claim 28, in which the upper wall of the suction chamber includes a first section that is angled downwardly from a central location to a first lateral side of the suction head and a second section that is angled downwardly from a central location to a second lateral side of the suction head.

30. A suction head for a vacuum cleaner according to claim 1, in which the airflow inducing means include a substantially tubular surface.

31. A suction head for a vacuum cleaner according to claim 30, in which the airflow inducing means induces substantially generally linear airflow.

32. A vacuum cleaner comprising a suction head wherein the suction head includes at least one air bleed having airflow inducing means in order to create an airflow directed substantially towards the surface to be cleaned.

33. A vacuum cleaner according to claim 32, in which the air bleed includes a vortex inducing means in order to create a vortex airflow directed substantially towards the surface to be cleaned.

34. A vacuum cleaner according to claim 32, in which the vacuum cleaner includes a cylinder type vacuum cleaner.

35. A vacuum cleaner according to claim 32, in which the vacuum cleaner includes an upright type vacuum cleaner.

36. A vacuum cleaner according to claim 32, in which the vacuum cleaner includes a handheld vacuum cleaner.

37. A method of agitating a surface to be cleaned comprising providing a suction head including a suction chamber having an open face to be located adjacent to a surface to be cleaned, the method including forming a vortex airflow directed substantially towards the surface to be cleaned within the suction chamber.

38. A method according to claim 37, in which the method includes forming a plurality of vortex airflows directed substantially towards the surface to be cleaned.
